(19) United States
(12) Patent Application Publication
(10) Pub. No.: US 2025/0051685 A1
(43) Pub. Date: Feb. 13, 2025

(54) METHOD AND SYSTEM FOR PREPARATION PROCESS OF MULTI-COMPOUND ESTER INSULATING OIL

(71) Applicant: CHONGQING UNIVERSITY, Chongqing (CN)

(72) Inventors: Feipeng WANG, Chongqing (CN); Jian ZHOU, Chongqing (CN); Qiang WANG, Chongqing (CN); Zhengyong HUANG, Chongqing (CN); Jian LI, Chongqing (CN); Weigen CHEN, Chongqing (CN); Yihua QIAN, Chongqing (CN); Yaohong ZHAO, Chongqing (CN); Qing WANG, Chongqing (CN)

(73) Assignee: CHONGQING UNIVERSITY, Chongqing (CN)

(21) Appl. No.: 18/776,284

(22) Filed: Jul. 18, 2024

(30) Foreign Application Priority Data
Aug. 7, 2023 (CN) 202310984030.X

(51) Int. Cl. C11C 3/00; C11B 1/10; C11B 3/12

(52) U.S. Cl. CPC C11C 3/003; C11B 1/10; C11B 3/12

(57) ABSTRACT

The invention discloses a method and system for preparing multi-compound ester insulating oil. The method utilizes vacuum esterification, involving esterification of pentaerythritol and fatty acid, followed by vacuum distillation, adsorption, washing, suction filtration, and vacuum drying to produce pure synthetic ester insulating oil. By detecting saturated fatty acid content, polarization strength, and closed-cup flash point, the most suitable natural ester insulating oil is selected. Ten different proportions of mixed ester insulating oils are obtained through blending and tested for mass and heat changes in nitrogen and air environments. Dielectric performance parameters at varying temperatures are analyzed to calculate activation energy. The resulting mixed ester insulating oil, NSE3 (85 vol % KA+15 vol % FR3), exhibits a high flash point, low pour point, and high AC breakdown voltage, offering excellent comprehensive performance. The physical, chemical, electrical, and thermal properties, along with the activation energy, have been significantly enhanced.

### TECHNICAL FIELD

The invention belongs to the field of insulating oil refining technology, more specifically, it relates to a method and a system for a preparation process of multi-compound ester insulating oil.

### BACKGROUND ART

As the key node equipment of the power grid, the performance status of the power transformer plays a decisive role in the safe, stable, and reliable operation of the power grid. As the ‘blood’ of the transformer, the insulating oil plays a dual important role in insulation protection and heat dissipation, which is the key to ensuring the safe and stable operation of the transformer as the key node equipment of the power grid.

Mineral insulating oil has been widely used in oil-immersed power transformers for hundreds of years. However, the flash point of mineral insulating oil is low, which makes it easy to cause explosion accidents; the mineral insulating oil also has poor biodegradability, which will cause serious environmental pollution when the oil leaks.

Ester-based insulating oil, including natural ester insulating oil and synthetic ester insulating oil, has excellent characteristics such as high flash point and strong biodegradability, which can effectively improve the operation stability and green environmental protection of transformers. However, there are some problems in natural ester insulating oils, which are characterized by high viscosity and obviously insufficient oxidation stability.

Compared with mineral insulating oil and natural ester insulating oil, synthetic ester insulating oil has excellent characteristics such as high safety, high environmental protection, low carbon emission, and strong oxidation stability. It has great application potential in offshore wind power, high-speed trains, traffic electrification, and other fields. However, the flash and ignition points of synthetic ester insulating oil are higher than those of mineral insulating oil, but there is still a certain gap between synthetic ester insulating oil and natural ester insulating oil. Moreover, the synthetic ester may have a very asymmetric molecular structure due to artificial synthesis, which in turn leads to a relatively high dielectric loss factor of the synthetic ester insulating oil; furthermore, the diversity of the molecular structure of the reaction raw materials and the complexity of organic synthesis will bring some difficulties to the production process of synthetic ester insulating oil, and the use of various synthetic raw materials will also increase the preparation cost.

From the perspective of cost and technical compatibility, the research work of improving flash point and reducing dielectric loss factor is further carried out based on the preparation of synthetic ester insulating oil with high flash point and low pour point, which can effectively promote the application of environmental protection power transformers in China.

The existing technical document 1 (CN111892981A) proposes a vegetable oil-based synthetic ester insulating oil and its manufacturing method. The insulating oil is prepared by the following steps: An epoxidation reaction of vegetable oil with peroxy acid is carried out, and then the product is reacted with organic acid to form isoester under the action of the catalyst, after removing impurities, and antioxidants and pour point depressants are added, which makes the insulating oil have better fire safety performance and excellent electrical insulation performance. The acid value is less than 0.03 mgKOH/g, the moisture content is less than 40 ppm, and the freezing point is reduced to −27° C., which can be applied to places with high fire resistance requirements. However, the deficiency of the existing technical document 1 is that the use of concentrated sulfuric acid as a catalyst requires vacuum distillation and solid adsorption after the reaction, which increases the complexity and cost of the process. The use of peroxy acid as an oxidizing agent requires the mixing of glacial acetic acid and hydrogen peroxide before the reaction, which increases the consumption and risk of raw materials.

### SUMMARY

In order to solve the shortcomings of the existing technology, the invention discloses a method and a system for a preparation process of multi-compound ester insulating oil and obtains a mixed ester insulating oil with excellent comprehensive performance. Based on the Reactive Force Field (ReaxFF), the thermal and electrical decomposition processes of mixed ester insulating oil, synthetic ester insulating oil, and natural ester insulating oil are simulated and analyzed. Combined with experiments, the performance evolution law after thermal aging and multiple AC breakdowns and the characteristics of dissolved gas in oil are explored, and the mechanism of thermal aging stability and AC breakdown tolerance difference of different kinds of ester insulating oil is revealed.

The invention adopts the following technical solution, the first aspect of the invention discloses a method for a preparation process of multi-compound ester insulating oil, comprising the following steps:
Step 1: putting polyol and compound fatty acids into a reaction vessel to obtain KA after preparation and purification;
Step 2: extracting a natural ester insulating oil from seed plants of main oil crops and carrying out a detection and analysis to obtain an FR3 for mixing;
Step 3: putting the KA obtained in Step 1 and FR3 obtained in Step 2 into the reaction vessel in batches, and carrying out an oscillation and vacuum drying to obtain a mixed ester insulating oil with FR3 proportion.

Preferably, Step 1 specifically comprises:
Step 1.1, putting the polyol and compound fatty acids into a thermostatic oil reservoir for esterification+vacuum distillation, a temperature is set to be greater than 100° C. and a stirring rate is 200-300 rpm;
Step 1.2, putting a product obtained in Step 1.1 into a digital constant temperature magnetic stirrer for adsorption, and the temperature is set to about 60° C.;
Step 1.3, putting a product obtained in Step 1.2 into the digital constant temperature magnetic stirrer for washing, and the temperature is set to about 60° C.;
Step 1.4, putting a product obtained in Step 1.3 into a circulating water vacuum pump for suction filtration, and using a 0.45-0.1 μm filter membrane for multiple filtration;
Step 1.5, putting a product obtained in Step 1.4 into a vacuum drying oven for drying, the temperature is set to 70° C. and a time is 48 h.

Preferably, in Step 1, the polyol is pentaerythritol;

the compound fatty acids comprise n-heptanoic acid, n-octanoic acid, isooctanoic acid, and n-decanoic acid.

Preferably, in Step 2, an oil crop seed vegetable oil comprises at least one of the following: palm oil, soybean oil, rapeseed oil, or sunflower seed oil.

Preferably, in Step 2, a content of the detection and analysis comprises saturated fatty acid content, polarization intensity, and closed-cup flash point.

Preferably, Step 3 comprises:

Step 3.1, pouring KA and FR3 slowly into a beaker in a state of stirring.

Step 3.2, placing an oil sample obtained in Step 3.1 in a constant temperature oscillation box to oscillate;

Step 3.3, after oscillating for a certain period, vacuum drying the oil sample at 90° C. for 48 h to ensure that a water content in the oil is less than 200 ppm, and obtaining ten kinds of mixed ester insulating oil NSE1-NSE10 with FR3 proportion.

Preferably, in Step 3, a FR3 proportion is 15 vol %.

The second aspect of the invention discloses a system for the preparation process of multi-compound ester insulating oil, which implements the multi-compound ester insulating oil preparation process method, comprising:
a synthesis and purification module used for a preparation of synthetic ester insulating oil;
a mixing module used for mixing synthetic ester insulating oil and natural ester insulating oil in different proportions and carrying out a detection and analysis.

Preferably, the synthesis and purification module comprises:
a constant temperature oil reservoir used for esterification+vacuum distillation;
a digital constant temperature magnetic stirrer used for adsorption and washing;
a circulating water vacuum pump and a vacuum oil pump used for suction filtration;
a vacuum drying oven used for vacuum drying.

Preferably, the mixing module comprises:
a digital constant temperature magnetic stirrer used for stirring and oscillation;
a vacuum drying oven used for drying degassing.

Compared with the existing technology, the beneficial effects of the invention include at least the following aspects:

(1) A method and a system for a preparation process of multi-compound ester insulating oil are proposed, and a mixed ester insulating oil with excellent comprehensive performance is obtained.

(2) Pentaerythritol ester insulating oil (KA) is prepared by vacuum esterification in the following five steps: esterification+vacuum distillation, adsorption, washing, suction filtration, and vacuum drying, and then the pure synthetic ester insulating oil is obtained.

(3) By comprehensively comparing the various indicators of different natural esters, it is confirmed that soybean oil is the best-mixed object, and ten kinds of mixed ester insulating oil NSE1-NSE10 with FR3 proportion are obtained.

(4) The pentaerythritol ester insulating oil (KA) is detected by Fourier transform infrared spectroscopy (FTIR), nuclear magnetic resonance spectroscopy (HNMR), and gas chromatography-mass spectrometry (GC-MS), it is further confirmed that the synthesis and preparation of KA insulating oil is successful, and its physicochemical and electrical properties are analyzed.

(5) From the perspective of economy and technical compatibility, a mixed blending method is adopted to further improve the flash combustion characteristics of synthetic ester insulating oil. In order to determine the optimal blending proportion, the mass and heat changes of the mixed ester insulating oil in nitrogen and air environments are tested and analyzed. According to the dielectric performance parameters at different temperatures, the activation energy of the mixed ester insulating oil is calculated. Finally, a mixed ester insulating oil with a high flash point, low pour point, and high AC breakdown voltage is screened from multiple groups of oil products.

(6) Based on Reactive Force Field (ReaxFF), the thermal and electrical decomposition processes of mixed ester insulating oil, synthetic ester insulating oil, and natural ester insulating oil are simulated and analyzed. Combined with experiments, the performance evolution law after thermal aging and multiple AC breakdowns and the characteristics of dissolved gas in oil are explored, and the mechanism of thermal aging stability and AC breakdown tolerance of different types of ester-based insulating oil is revealed.

(7) The preparation method is simpler and more effective than the existing document 1.

(8) The preparation process is more material-saving and safer than the existing document 1.

### BRIEF DESCRIPTION OF THE DRAWINGS

FIG. 1 is a preparation flow chart of KA insulating oil;

FIG. 2a is an infrared spectroscopy of KA insulating oil;

FIG. 2b is a nuclear magnetic resonance spectroscopy of KA insulating oil;

FIG. 2c is a gas chromatography-mass spectrometry of KA insulating oil;

FIG. 3 is a preparation flow chart of the mixed ester insulating oil;

FIG. 4a is a relationship between the infrared spectral absorption intensity of H—C(═C) bond of NSE1-NSE10 insulating oil and the proportions of FR3;

FIG. 4b is a relationship between the infrared spectral absorption intensity of C—H bond of NSE1-NSE10 insulating oil and the proportions of FR3;

FIG. 4c is a relationship between the infrared spectral absorption intensity of C═O bond of NSE1-NSE10 insulating oil and the proportions of FR3;

FIG. 4d is a relationship between the infrared spectral absorption intensity of C(═O)—O—C bond of NSE1-NSE10 insulating oil and the proportions of FR3;

FIG. 5a is a variation of closed-cup flash point of the mixed ester insulating oil with FR3 proportions (vol %);

FIG. 5b is a variation of open cup flash point of the mixed ester insulating oil with FR3 proportions (vol %);

FIG. 5c is a variation of ignition point of the mixed ester insulating oil with FR3 proportions (vol %);

FIG. 5d is a variation of pour point of the mixed ester insulating oil with FR3 proportions (vol %);

FIG. 6 is a variation of the AC breakdown voltage of mixed ester insulating oil with the FR3 proportion (vol %);

FIG. 7a is a variation of dielectric constant of mixed ester insulating oil with FR3 proportions (vol %);

FIG. 7b is a variation of dielectric loss factor of mixed ester insulating oil with FR3 proportions (vol %);

FIG. 7c is a variation of DC resistivity of mixed ester insulating oil with FR3 proportions (vol %);

FIG. 8a is a logarithmic value of dielectric loss factor of KA, NSE1-NSE4 insulating oil at 298, 323, 343, 363 K and a corresponding fitted straight line diagram;

FIG. 8b is a logarithmic value of DC resistivity of KA, NSE1-NSE4 insulating oil at 298, 323, 343, 363 K and a corresponding fitted straight line diagram;

FIG. 9 is an activation energy diagram of KA, NSE1-NSE4 insulating oil calculated according to the dielectric loss factor and DC resistivity.

FIG. 10a is a TG-DTG-DSC diagram of KA in a nitrogen environment;

FIG. 10b is a TG-DTG-DSC diagram of NSE1 insulating oil in a nitrogen environment;

FIG. 10c is a TG-DTG-DSC diagram of NSE2 insulating oil in a nitrogen environment;

FIG. 10d is a TG-DTG-DSC diagram of NSE3 insulating oil in a nitrogen environment;

FIG. 10e is a TG-DTG-DSC diagram of NSE4 insulating oil in a nitrogen environment;

FIG. 11a is a TG-DTG-DSC diagram of KA in an air environment;

FIG. 11b NSE1 is a TG-DTG-DSC diagram of NSE1 insulating oil in an air environment;

FIG. 11b NSE2 is a TG-DTG-DSC diagram of NSE2 insulating oil in an air environment;

FIG. 11c is a TG-DTG-DSC diagram of NSE3 insulating oil in an air environment;

FIG. 11d is a TG-DTG-DSC diagram of NSE4 insulating oil in an air environment;

### DETAILED DESCRIPTION OF THE EMBODIMENTS

In order to make the purpose, technical solution, and advantages of the invention clearer, the technical solution of the invention will be described clearly and completely in the following in combination with the attached figures in the embodiment of the invention. The embodiments described in this application are only part of the embodiments of the invention, not all of the embodiments. Based on the spirit of the invention, other embodiments obtained by ordinary technicians in this field without creative labor belong to the scope of protection of the invention.

The mixed ester insulating oil NSE3 with excellent comprehensive performance is obtained by mixing the synthesized ester insulating oil with the preferred natural ester insulating oil. It can be comparable to the commercial synthetic ester insulating oil MIDEL 7131 and has a higher closed-cup flash point, ignition point, and AC breakdown voltage. At the same time, NSE3 has better AC breakdown tolerance than its component KA from a macro perspective and has the potential to be applied in environmentally friendly power transformers.

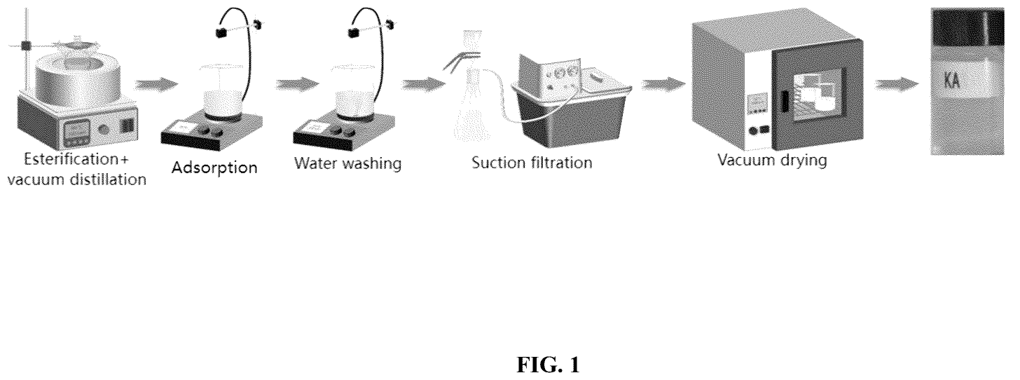

As shown in FIG. 1, Embodiment 1 of the invention discloses a method and a system for a preparation process of multi-compound ester insulating oil, comprising the following steps:
Step 1: The polyol and compound fatty acids are put into a reaction vessel to obtain pentaerythritol ester insulating oil (KA) after preparation and purification;

In a preferred but non-restrictive embodiment of the invention, Step 1 specifically comprises:
Step 1.1, the polyol and compound fatty acids are put into a thermostatic oil reservoir for esterification+vacuum distillation, the temperature range is 100-150° C. and it is set to be 130° C. and the stirring rate is 200-300 rpm;
Step 1.2, the product obtained in Step 1.1 is put into a digital constant temperature magnetic stirrer for adsorption, and the temperature is set to about 60° C.;
Step 1.3, the product obtained in Step 1.2 is put into the digital constant temperature magnetic stirrer for washing, and the temperature is set to about 60° C.;
Step 1.4, the product obtained in Step 1.3 is put into a circulating water vacuum pump for suction filtration, and using a 0.45-0.1 μm filter membrane for multiple filtration;
Step 1.5, the product obtained in Step 1.4 is put into a vacuum drying oven for drying, the temperature is set to 70° C. and the time is 48 h.

In a preferred but non-restrictive embodiment of the invention, the compound saturated fatty acids comprise branched-chain fatty acids and straight-chain fatty acids, specifically, the compound fatty acids comprise n-heptanoic acid, n-octanoic acid, isooctanoic acid, and n-decanoic acid, and pentaerythritol is selected for the polyol.

It is worth noting that under the premise of ensuring that its own fluidity and oxidation stability are less affected, the invention adopts a mixed blending method from the perspective of economy and technical compatibility to obtain a synthetic ester insulating oil with the best comprehensive performance.

In the preferred but non-restrictive embodiment of the invention, when preparing and purifying the synthetic ester insulating oil, the invention adopts the following five steps to obtain a product with excellent performance: \textcircled{1} esterification+vacuum distillation; \textcircled{2} adsorption; \textcircled{3} washing; \textcircled{4} suction filtration; \textcircled{5} vacuum drying. The experimental instruments mainly comprise a constant temperature oil reservoir, digital constant temperature magnetic stirrer, circulating water vacuum pump, vacuum oil pump, vacuum drying box, and so on.

It is worth noting that the above experimental instruments are only a kind of instrument selection in the experimental environment. In engineering practice, any reaction vessel with temperature and vacuum control used by the technical personnel in this field to implement the invention falls within the scope of the invention.

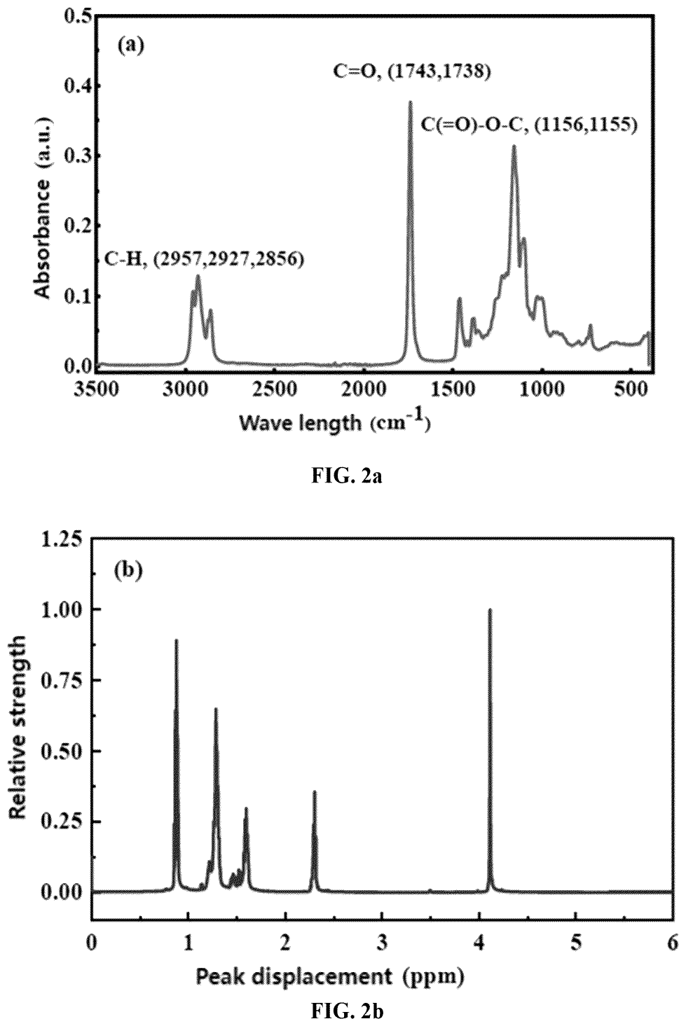

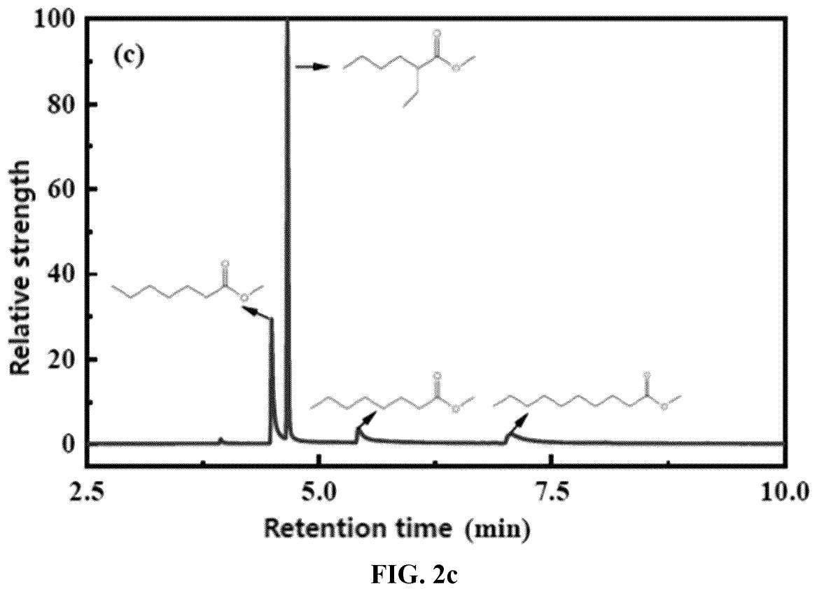

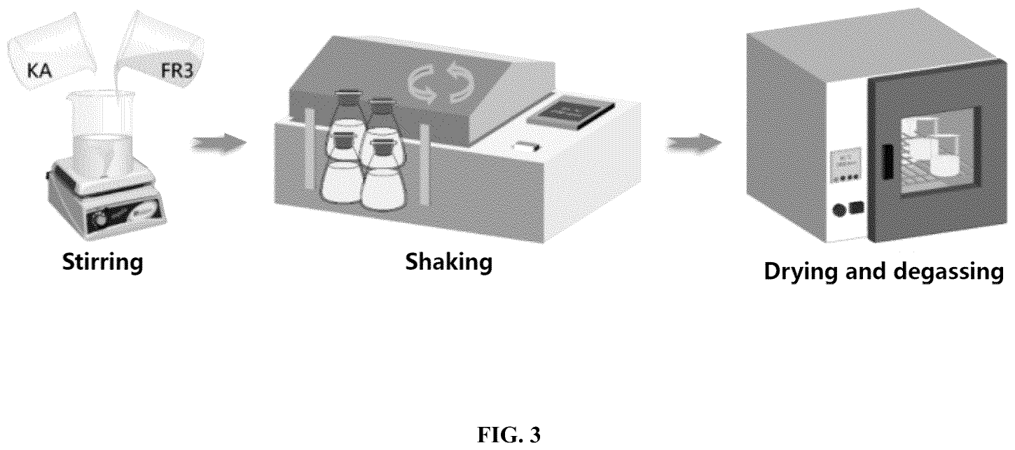

It is worth noting that, as shown in FIG. 2, in order to highlight the beneficial technical effects that the invention can achieve, the invention will explore the structural characterization of the prepared synthetic ester insulating oil KA to ensure the rationality of the product. The structural characterizations of the three parameters of Fourier transform infrared spectroscopy (FTIR), nuclear magnetic resonance hydrogen spectroscopy (H NMR), and gas chromatography mass spectrometry (GC-MS) of KA are analyzed, which indicate that the synthesis and preparation of KA insulating oil is successful.

In the Fourier transform infrared spectrum, 1743 and 1738 cm⁻¹ appeared strong absorption peaks caused by the stretching vibration of the C═O bond, which were typical characteristic peaks of esters. There are also strong absorption peaks at 1156 and 1155 cm⁻¹, which are caused by the stretching vibration of the C(—O)—O—C bond, the peaks at 2957, 2927, and 2856 cm⁻¹ are caused by the stretching and bending vibration of CH3 and CH2 groups.

In the nuclear magnetic resonance hydrogen spectroscopy, 1H NMR (600 MHZ, Chloroform-d) δ4.10 (s, 8H, 4×(—O—CH2-)), 2.29 (t, 8H, 4×(—CO—CH2-)), 1.59 (t, 8H, 4×

(—CO—CH2-CH2)), 1.27 (m, 24H), 0.87 (td, 16H, 5×(—CH3)). Therefore, there is a (—O—CH2-) signal at 4.10 ppm, a (—C(O)—CH2-) signal at 2.29 ppm, and a (—CO—CH2-CH2) signal at 1.59 ppm. In addition, the 0.87 ppm signal indicates that the number of methyl groups in the sample molecule is greater than four, indicating that there must be branched fatty acid chains.

In gas chromatography mass spectrometry, the presence of methyl heptanoate, methyl isooctanoate, methyl octanoate, and methyl decanoate is determined, and their retention times are 4.493, 4.663, 5.424, and 7.058 min, respectively. According to the size of the peak area, the proportion of the above four products is approximately 3:6:1:1, which is similar to the proportion of fatty acids input before the esterification reaction, which confirms that the compound fatty acids are more thoroughly esterification with pentaerythritol.

Step 2: The natural ester insulating oil is extracted from seed plants of the main oil crops and a detection and analysis is carried out to obtain the best natural ester insulating oil (FR3) for mixing;

In a preferred but non-restrictive embodiment of the invention, the natural ester insulating oils comprise palm oil, soybean oil, rapeseed oil, sunflower seed oil, and camellia seed oil.

It is worth noting that because the energy gap of saturated fatty acid esters is higher than that of unsaturated fatty acid esters, the chemical stability of natural esters with more saturated fatty acid esters is stronger, so palm oil and soybean oil can be considered to have excellent chemical stability. In terms of polarization intensity, the polarization intensity of soybean oil is lower (1.475*10⁻³ D/Å3), followed by rapeseed oil (1.481*10⁻³ D/Å3) and sunflower seed oil (1.681*10⁻³ D/Å3), and the polarization intensity of palm oil is lower (2.332*10⁻³ D/Å3) The rapeseed oil and soybean oil have higher closed-cup flash points, which can more effectively improve the closed-cup flash point of KA. Therefore, by comprehensively comparing several indicators of different natural esters, it can be found that soybean oil can better balance the annual output, price cost, chemical stability, polarization intensity, and flash combustion characteristics. Soybean oil-based natural ester insulating oil FR3 is selected as a mixed object to improve the flash combustion characteristics of KA and further improve the dielectric properties of KA.

Step 3: the KA obtained in Step 1 and FR3 obtained in Step 2 are put into the reaction vessel in batches, and an oscillation and vacuum drying are carried out to obtain a mixed ester insulating oil with FR3 proportion.

In a preferred but non-restrictive embodiment of the invention, Step 3 specifically comprises:

Step 3.1, KA and FR3 are poured slowly into a beaker in a state of stirring.

Step 3.2, the oil sample obtained in Step 3.1 is placed in a constant temperature oscillation box to oscillate;

Step 3.3, after oscillating for a certain period, the oil sample is vacuum dried at 90° C. for 48 h to ensure that the water content in the oil is less than 200 ppm, and ten kinds of mixed ester insulating oil NSE1-NSE10 with FR3 proportion (5, 10, 15, 20, 25, 30, 35, 40, 45, 50 vol %) are obtained.

It is worth noting that the invention analyzes the structure and performance characterization of the prepared mixed ester insulating oil to illustrate whether the preparation of the mixed ester insulating oil is successful. Specifically, it comprises flash point, ignition point and pour point, AC breakdown voltage, dielectric constant, dielectric loss factor, and DC resistivity.

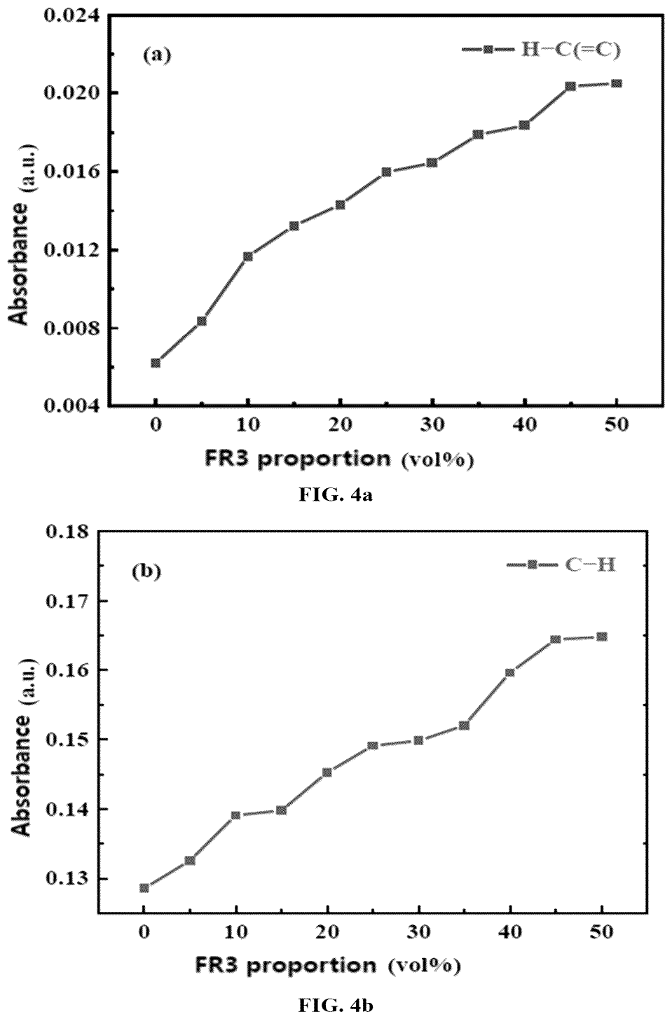

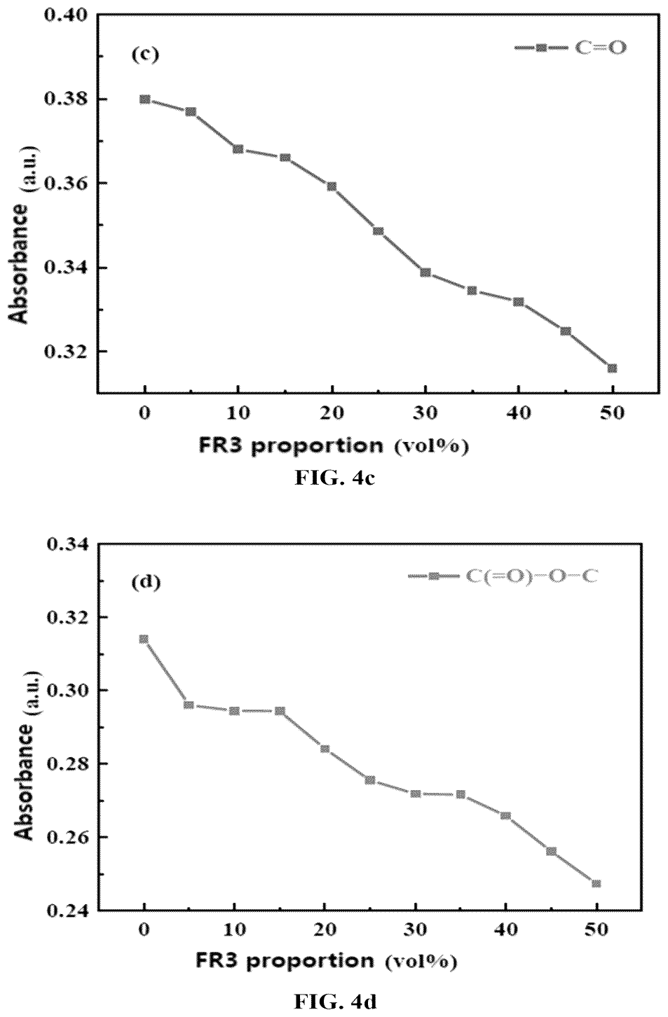

As shown in FIG. 4, the absorption intensity of the C═C bond in mixed ester insulating oil increases approximately linearly with the increase of FR3 proportion (vol %), and the absorption intensity of H—C(═C) bond in NSE10 is more than three times that of NSE1. The absorption intensities of C—H, C═O, and C(═O)—O—C bonds also show an approximately linear relationship with FR3 proportion (vol %). Specifically, when the FR3 proportion increases from 0 vol % to 50 vol %, the absorption intensity of the C—H bond gradually increases from 0.13 to 0.16, the absorption intensity of the C═O bond gradually decreases from 0.38 to 0.32, and the absorption intensity of C(—O)—O—C bond gradually decreases from 0.31 to 0.25. It shows that the preparation of mixed ester insulating oil is very successful.

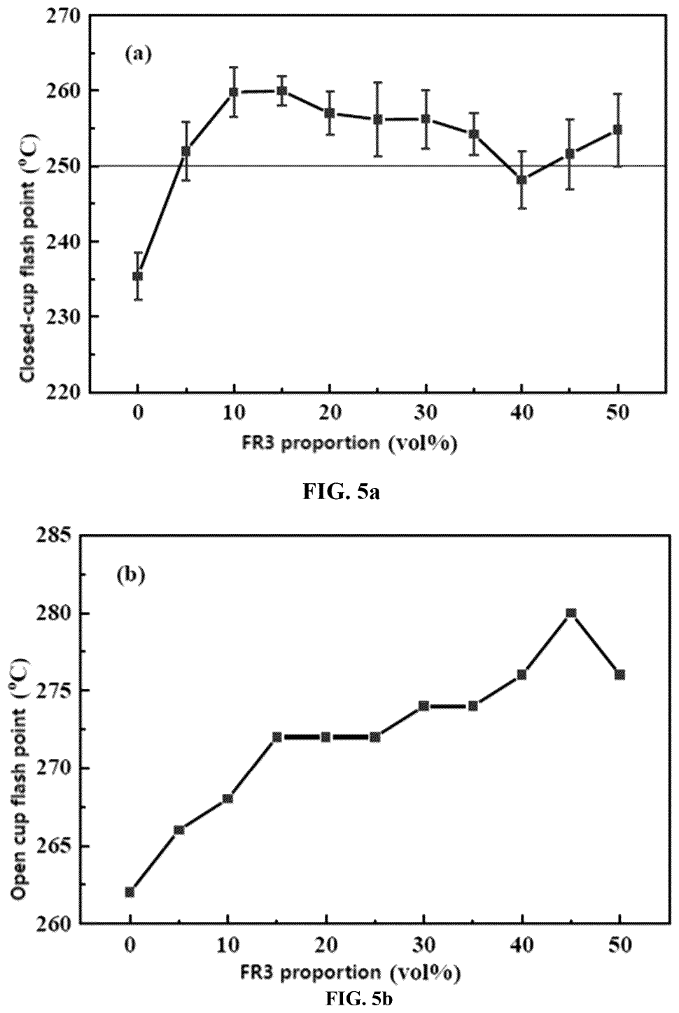

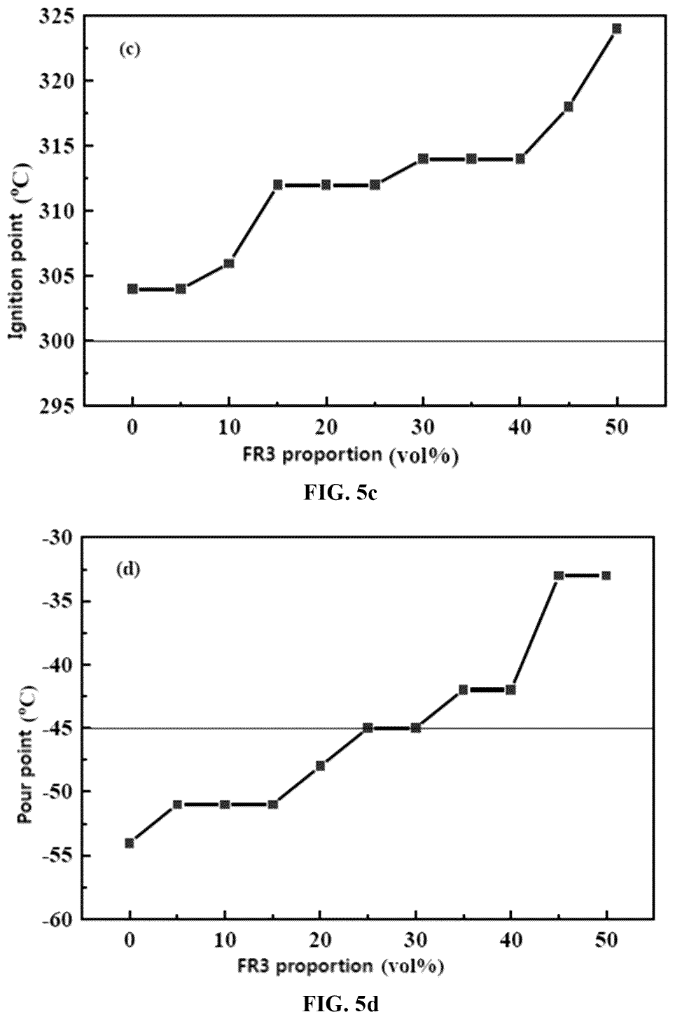

As shown in FIG. 5, the closed-cup flash point of mixed ester insulating oil has a non-linear relationship with the FR3 proportion, but the closed-cup flash point of all mixed ester insulating oil is higher than that of KA. When the FR3 proportion is 5-35 vol %, the closed-cup flash point of the mixed ester insulating oil meets the requirements (≥250° C.). When FR3 accounts for 40 vol %, the closed-cup flash point of the mixed ester insulating oil is less than 250° C., which does not meet the requirements. When FR3 accounts for 10 and 15 vol %, the closed-cup flash point of the mixed ester insulating oil reaches the highest, which is more than 10% higher than that of KA. The open cup flash point of mixed ester insulating oil is approximately linear with the FR3 proportion (vol %). The open cup flash point of mixed ester insulating oil reaches the highest (280° C.) when the FR3 proportion is 45 vol %, which is about 6.9% higher than that of KA. The ignition point of mixed ester insulating oil increases approximately linearly with the increase of FR3 proportion. When FR3 proportion accounts for 50 vol %, the ignition point of the mixed ester insulating oil reaches 324° C., which is 20° C. higher than that of KA. Therefore, it can be concluded that compared with KA, the mixed ester insulating oil exhibits a higher flash point and ignition point, and has good compatibility between KA and FR3, NSE1-NSE3 shows the best low-temperature fluidity.

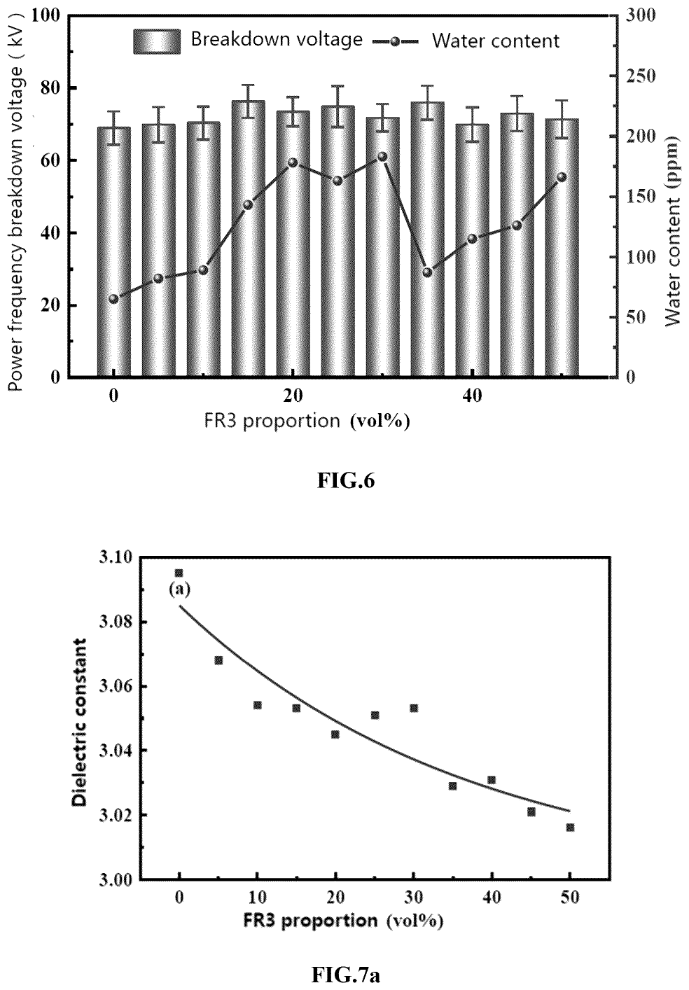

As shown in FIG. 6, the AC breakdown voltage of the mixed ester insulating oil is significantly higher than that of KA and is greater than 45 kV, the mixed ester insulating oil with FR3 proportion of 15, 25 and 35 vol % has relatively high AC breakdown voltage, when the FR3 proportion is 15 vol %, the AC breakdown voltage of the mixed ester insulating oil is 76.6 kV, which is nearly 13% higher than that of KA.

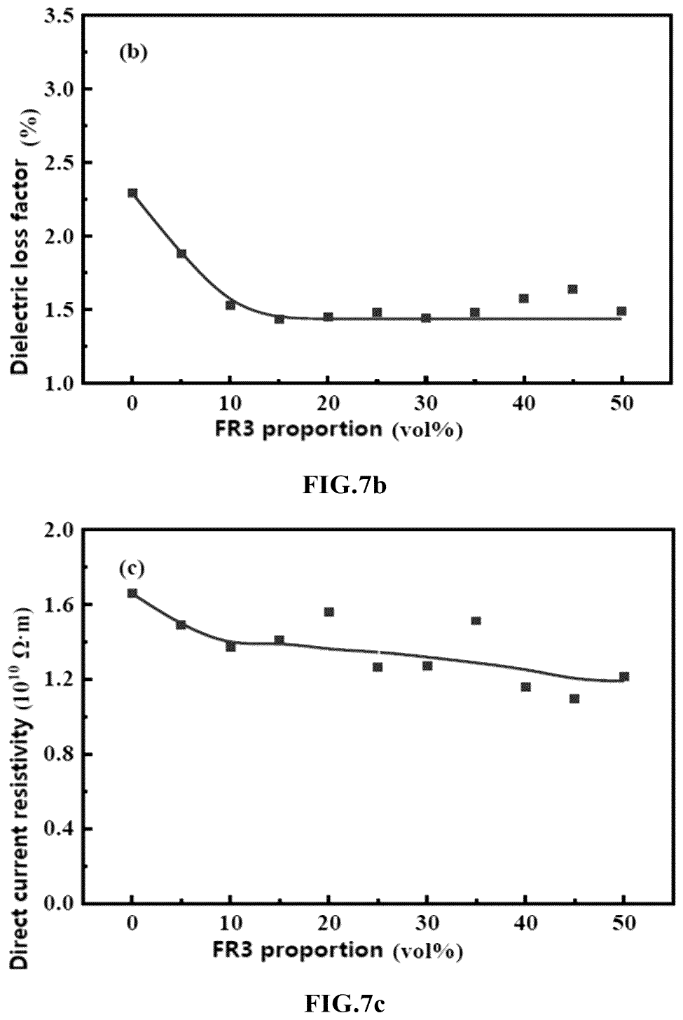

As shown in FIG. 7, the dielectric constant of mixed ester insulating oil decreases with the increase of FR3 proportion, the dielectric constant of the mixed ester insulating oil reaches the lowest (3.016) when FR3 accounts for 50 vol %, but it is still greater than the dielectric constant of FR3 (2.8). With the increase of FR3 proportion (vol %), the dielectric loss factor of mixed ester insulating oil decreases sharply first and then tends to be gentle. When the FR3 proportion is 15 vol %, the dielectric loss factor of the mixed ester insulating oil can reach the lowest (1.44%), which is 0.86% lower than that of KA, when FR3 accounts for 45 vol %, the DC resistivity of the mixed ester insulating oil reaches the lowest (1.097×1010 Ω·m), but still meets the requirement of more than 0.2×1010 Ω·m. All these results show that the mixed ester insulating oil has excellent performance, which can effectively delay the aging of insulating paper, and then prolong the operating life of transformers.

It is worth noting that in order to highlight the beneficial technical effects that the invention can achieve, ten different mixing proportions will be optimized to ensure that the prepared mixed ester insulating oil has the best comprehensive performance.

The pour point of NSE5 and NSE6 is −45° C., which is the required critical value of the pour point of synthetic ester insulating oil, in order to retain the margin and ensure the safe and stable operation of power transformers under low-temperature environmental conditions, NSE5-NSE10 are no longer included in the consideration of the best-mixed ester insulating oil. Therefore, 20 vol % is taken as the critical proportion, and further discussion is carried out around KA, NSE1-NSE4.

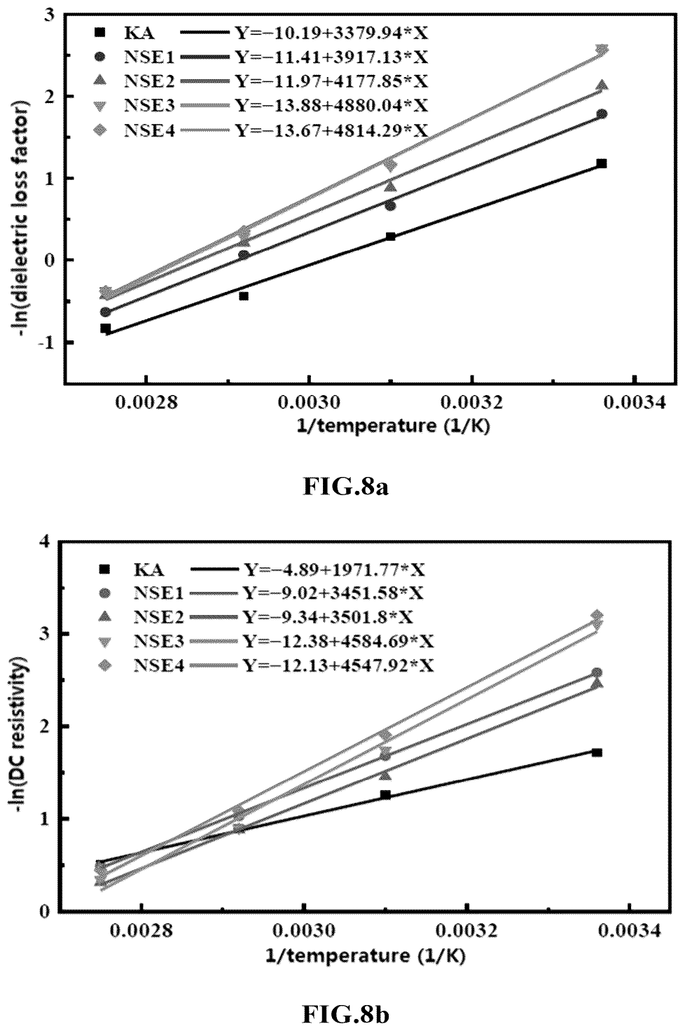

As shown in FIG. 8, the logarithmic values of the dielectric loss factor and DC resistivity of KA and NSE1-NSE4 at 298, 323, 343, and 363 K are obtained, and the logarithmic values of dielectric loss factor and DC resistivity at corresponding temperatures are linearly fitted. The fitting effect of dielectric loss factor and DC resistivity is good, the fitting coefficients of KA and NSE1-NSE4 dielectric loss factors are 0.95, 0.98, 0.99, 0.99 and 0.99, respectively, and the fitting coefficients of DC resistivity are 0.99, 0.99, 0.99, 0.98 and 0.99, respectively. The activation energy can be calculated as follows:

$$\{ \begin{matrix}y = - k \cdot \frac{ln \frac{{DF}_{T 1}}{{DF}_{T 2}}}{\frac{1}{T 1} - \frac{1}{T 2}} \\ y = k \cdot \frac{ln \frac{{Resis}_{T 1}}{{Resis}_{T 2}}}{\frac{1}{T 1} - \frac{1}{T 2}}\end{matrix}$$

wherein k is Boltzmann constant, DF_{T1}, DF_{T2}, Resis_{T1}, Resis_{T2} are the dielectric loss factors and DC resistivity values at T1 and T2 temperatures, T1 and T2 are temperature values.

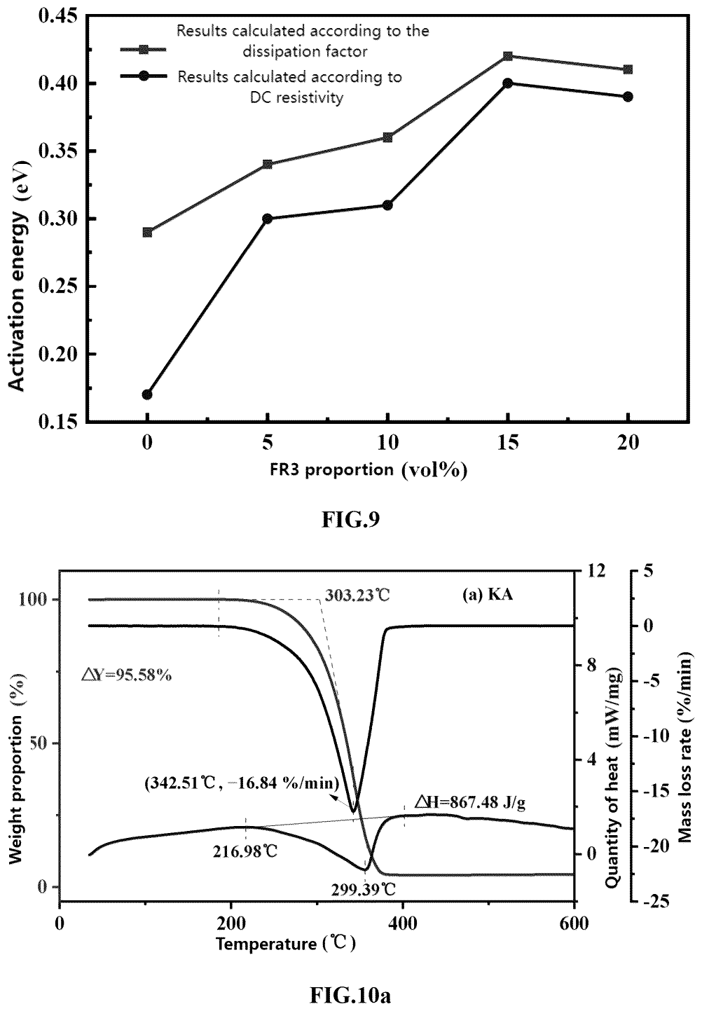

The slope of the above linear fitting line is used to represent −ln(DF_{T1}/DF_{T2})/(1/T1−1/T2) and ln(Resis_{T1}/Resis_{T2})/(1/T1−1/T2), and then it is multiplied by k to obtain the activation energy calculation results. As shown in FIG. 9, the activation energy increases first and then decreases with the increase of FR3 proportion, and reaches the maximum when the FR3 proportion is 15 vol %.

By analyzing the thermal properties of KA, NSE1-NSE4, and FR3, the optimal blending proportion of mixed ester insulating oil is further selected. The thermal properties of insulating oil are tested and analyzed by thermogravimetric-thermogravimetric differential-differential scanning calorimetry (TG-DTG-DSC). The initial pyrolysis, initial thermal oxygen decomposition temperature, and peak temperature of pyrolysis and thermal oxygen decomposition of insulating oil can be obtained from the DSC curve. At the same time, the thermal gain or heat dissipation of insulating oil can be obtained by analyzing the DSC curve peak; the maximum weight loss rate and its corresponding time can be obtained through the DTG curve; the extrapolated onset temperature can be obtained by combining the TG and DTG curves.

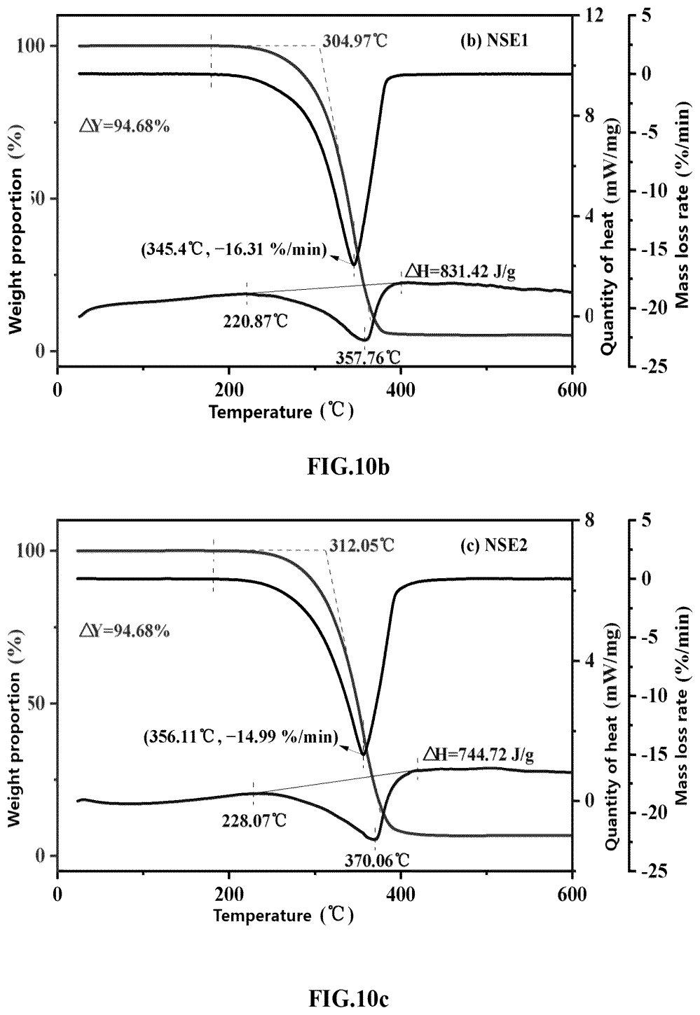

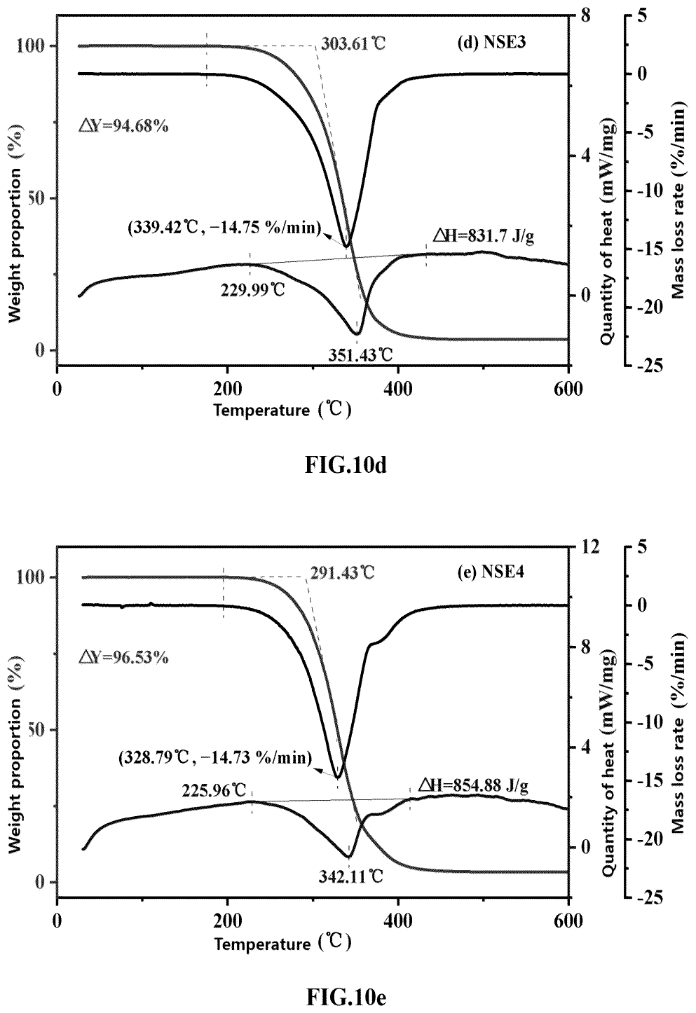

The TG-DTG-DSC test results of KA and NSE1-NSE4 in a nitrogen environment are shown in FIG. 10. The initial pyrolysis temperature of KA is 216.98° C., the extrapolated initial temperature is 303.23° C., the pyrolysis peak temperature is 299.39° C., and the thermal gain is 867.48 J/g. The initial pyrolysis temperatures of NSE1-NSE4 are higher than that of KA, which are 220.87° C., 228.07° C., 229.99° C. and 225.96° C., respectively. In addition, the pyrolysis peak temperatures of NSE1-NSE4 are higher than those of KA, which are 357.76, 370.06, 351.43, and 342.11° C., respectively. However, the thermal gains of NSE1-NSE4 are less than those of KA, which are 831.42, 744.72, 831.7, and 854.88 J/g, respectively. But in general, the thermal performance of KA in a nitrogen environment is improved after adding FR3.

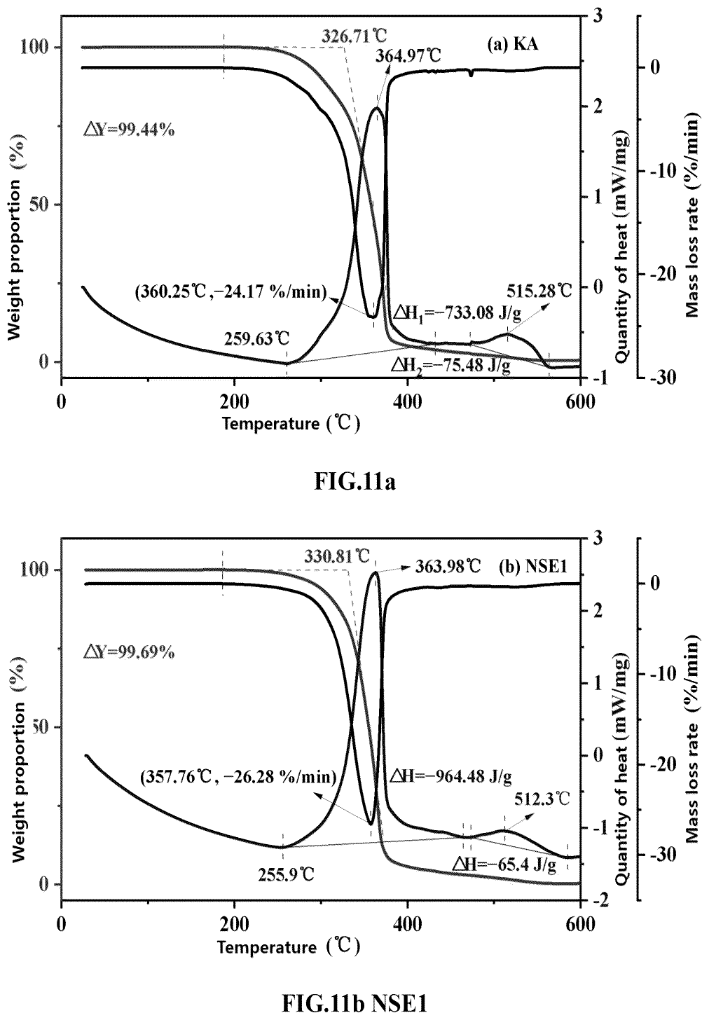

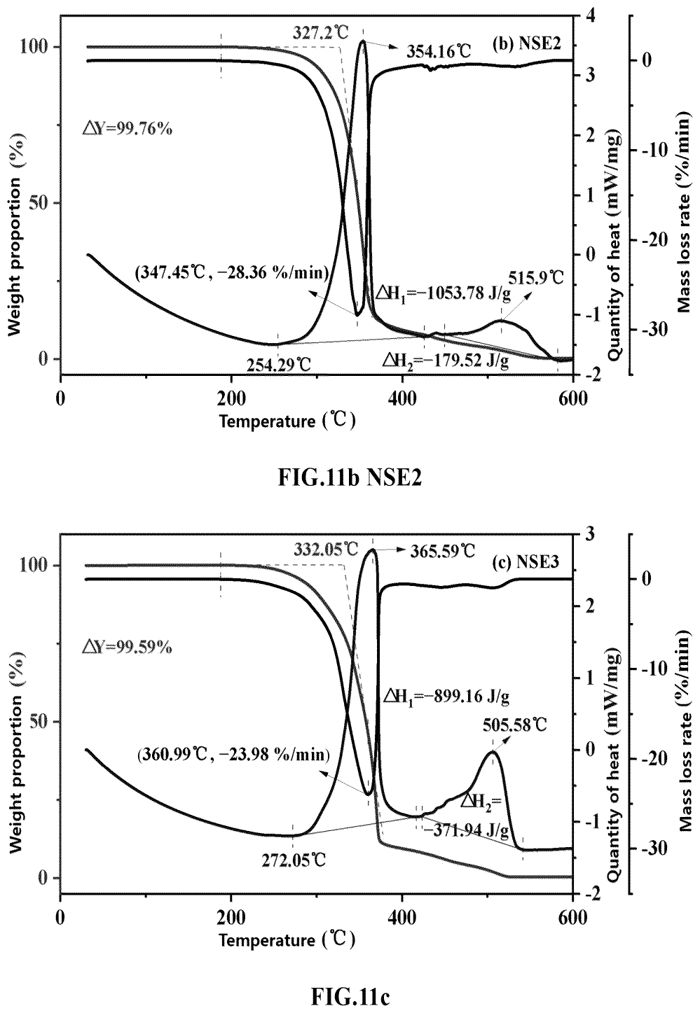

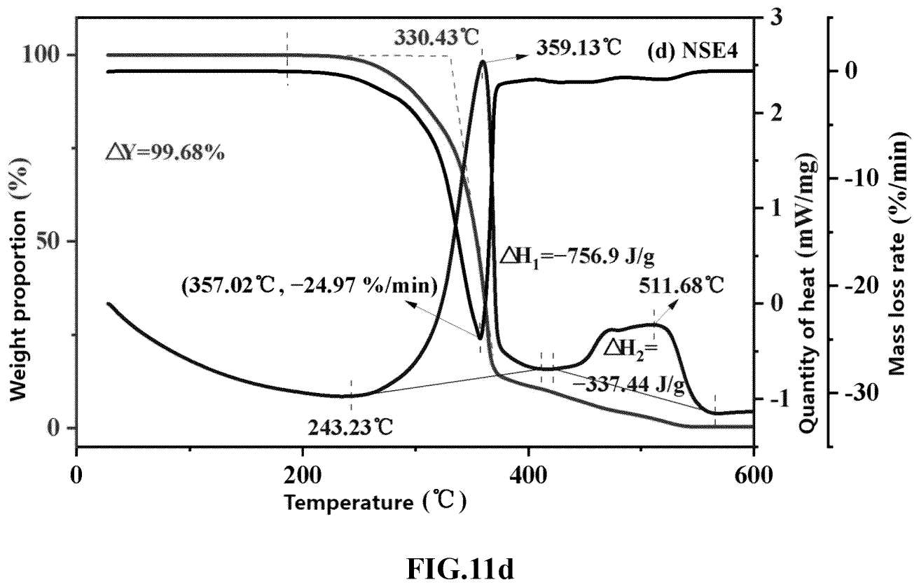

The TG-DTG-DSC test results of KA and NSE1-NSE4 in an air environment are shown in FIG. 11, after adding FR3, the heat dissipation of KA is increased significantly, the extrapolated initial temperature and the peak temperature of weight loss rate are not changed significantly, and the initial thermal oxygen decomposition temperature is decreased (except NSE3). In summary, under air conditions, the addition of FR3 will have a slight effect on the thermal performance of KA.

Considering the thermal performance under nitrogen, NSE3 has a higher extrapolated initial temperature (303.61° C.), pyrolysis peak temperature (351.43° C.), and weight loss rate peak temperature (339.42° C.), and has the highest initial pyrolysis temperature (229.99° C.). Considering the thermal performance under air, although NSE3 has the largest total heat dissipation (−1271.1 J/g), it has the highest extrapolated initial temperature (332.05° C.), initial thermal oxygen decomposition temperature (272.05° C.) and the first thermal oxygen decomposition peak temperature (365.59° C.), weight loss rate peak temperature (360.99° C.) and maximum weight loss rate (generation value, −23.98%/min).

Therefore, it can be determined that NSE3 is a mixed ester insulating oil with an excellent comprehensive performance by comprehensively analyzing the physical and chemical properties, electrical properties, thermal properties, and activation energy of NSE1-NSE4.

It is worth noting that NSE3 has obvious advantages compared with the physical, chemical, and electrical properties of KA and MIDEL 7131. In terms of physical and chemical properties, the closed-cup flash point, open cup flash point, and ignition point of KA increase from 236° C., 262° C. and 304° C. to 260° C., 272° C. and 312° C. respectively after adding 15 vol % FR3; the pour point only increased slightly, maintaining good low-temperature fluidity; the kinematic viscosity and acid value remain almost unchanged. In terms of electrical properties, the AC breakdown voltage of KA increases from 67.6 kV to 76.5 kV, the dielectric loss factor decreases from 2.295% to 1.44%, and the DC resistivity and dielectric constant barely change after adding 15 vol % FR3. Generally, the dielectric properties of KA have been improved. Therefore, NSE3 (85 vol % KA+15 vol % FR3) is identified as a mixed ester insulating oil with excellent comprehensive performance.

Embodiment 2 of the invention discloses a system for the preparation process of multi-compound ester insulating oil, which comprises:
a synthesis and purification module used for the preparation of synthetic ester insulating oil;
a mixing module used for mixing synthetic ester insulating oil and natural ester insulating oil in different proportions and carrying out a detection and analysis.

In a further preferred but non-restrictive embodiment, the synthesis and purification module comprises:
a constant temperature oil reservoir used for esterification+vacuum distillation; a digital constant temperature magnetic stirrer used for adsorption and washing; a circulating water vacuum pump and a vacuum oil pump used for suction filtration; a vacuum drying oven used for vacuum drying.

In a further preferred but non-restrictive embodiment, the mixing module comprises:
a digital constant temperature magnetic stirrer used for stirring and oscillation; a vacuum drying oven used for drying degassing.

The beneficial effect of the invention is that, compared with the existing technology.

(1) A method and a system for a preparation process of multi-compound ester insulating oil are proposed, and a mixed ester insulating oil with excellent comprehensive performance is obtained.

(2) Pentaerythritol ester insulating oil (KA) is prepared by vacuum esterification in the following five steps: esterification+vacuum distillation, adsorption, washing, suction filtration, and vacuum drying, and then the pure synthetic ester insulating oil is obtained.

(3) By comprehensively comparing the various indicators of different natural esters, it is confirmed that soybean oil is the best-mixed object, and ten kinds of mixed ester insulating oil NSE1-NSE10 with FR3 proportion are obtained.

(4) The pentaerythritol ester insulating oil (KA) is detected by Fourier transform infrared spectroscopy (FTIR), nuclear magnetic resonance spectroscopy (HNMR), and gas chromatography-mass spectrometry (GC-MS), it is further confirmed that the synthesis and preparation of KA insulating oil is successful, and its physicochemical and electrical properties are analyzed.

(5) From the perspective of economy and technical compatibility, a mixed blending method is adopted to further improve the flash combustion characteristics of synthetic ester insulating oil. In order to determine the optimal blending proportion, the mass and heat changes of the mixed ester insulating oil in nitrogen and air environments are tested and analyzed. According to the dielectric performance parameters at different temperatures, the activation energy of the mixed ester insulating oil is calculated. Finally, a mixed ester insulating oil with a high flash point, low pour point, and high AC breakdown voltage is screened from multiple groups of oil products.

(6) Based on Reactive Force Field (ReaxFF), the thermal and electrical decomposition processes of mixed ester insulating oil, synthetic ester insulating oil, and natural ester insulating oil are simulated and analyzed. Combined with experiments, the performance evolution law after thermal aging and multiple AC breakdowns and the characteristics of dissolved gas in oil are explored, and the mechanism of thermal aging stability and AC breakdown tolerance of different types of ester-based insulating oil is revealed.

(7) The preparation method is simpler and more effective than the existing document 1.

(8) The preparation process is more material-saving and safer than the existing document 1.

Finally, it should be stated that the above embodiments are only used to explain the technical solution of the invention rather than to limit it. Although the invention is described in detail concerning the above embodiments, the general technical personnel in the field should understand that those specific embodiments of the invention can still be modified or equivalently replaced, and any modification or equivalent replacement that does not deviate from the spirit and scope of the invention should be covered within the scope of protection of the invention.

What is claimed is:

1. A method for a preparation process of multi-compound ester insulating oil, comprising the following steps:
Step 1: putting polyol and compound fatty acids into a reaction vessel to obtain KA after preparation and purification;
Step 2: extracting a natural ester insulating oil from seed plants of main oil crops and carrying out a detection and analysis to obtain an FR3 for mixing; and
Step 3: putting the KA obtained in Step 1 and FR3 obtained in Step 2 into the reaction vessel in batches, and carrying out an oscillation and vacuum drying to obtain a mixed ester insulating oil with FR3 proportion.

2. The method for the preparation process of multi-compound ester insulating oil according to claim 1, wherein Step 1 specifically comprises:
Step 1.1, putting the polyol and compound fatty acids into a thermostatic oil reservoir for esterification+vacuum distillation, a temperature is set to be greater than 100° C. and a stirring rate is 200-300 rpm;
Step 1.2, putting a product obtained in Step 1.1 into a digital constant temperature magnetic stirrer for adsorption, and the temperature is set to about 60° C.;
Step 1.3, putting a product obtained in Step 1.2 into the digital constant temperature magnetic stirrer for washing, and the temperature is set to about 60° C.;
Step 1.4, putting a product obtained in Step 1.3 into a circulating water vacuum pump for suction filtration, and using a 0.45-0.1 μm filter membrane for multiple filtration; and
Step 1.5, putting a product obtained in Step 1.4 into a vacuum drying oven for drying, the temperature is set to 70° C. and a time is 48 h.

3. The method for the preparation process of multi-compound ester insulating oil according to claim 2, wherein in Step 1, the polyol is pentaerythritol; and the compound fatty acids comprise n-heptanoic acid, n-octanoic acid, isooctanoic acid, and n-decanoic acid.

4. The method for the preparation process of multi-compound ester insulating oil according to claim 1, wherein in Step 2, an oil crop seed vegetable oil comprises at least one of the following: palm oil, soybean oil, rapeseed oil, or sunflower seed oil.

5. The method for the preparation process of multi-compound ester insulating oil according to claim 1, wherein in Step 2, a content of the detection and analysis comprises saturated fatty acid content, polarization intensity, and closed-cup flash point.

6. The method for the preparation process of multi-compound ester insulating oil according to claim 1, wherein Step 3 comprises:
Step 3.1, pouring KA and FR3 slowly into a beaker in a state of stirring;
Step 3.2, placing an oil sample obtained in Step 3.1 in a constant temperature oscillation box to oscillate; and
Step 3.3, after oscillating for a certain period, vacuum drying the oil sample at 90° C. for 48 h to ensure that a water content in the oil is less than 200 ppm, and obtaining ten kinds of mixed ester insulating oil NSE1-NSE10 with FR3 proportion.

7. The method for the preparation process of multi-compound ester insulating oil according to claim 6, wherein in Step 3, an FR3 proportion is 15 vol %.

8. A system for the preparation process of multi-compound ester insulating oil, it implements the multi-compound ester insulating oil preparation process method according to claim 1, comprising:
a synthesis and purification module used for a preparation of synthetic ester insulating oil; and
a mixing module used for mixing synthetic ester insulating oil and natural ester insulating oil in different proportions and carrying out a detection and analysis.

9. The system for the preparation process of multi-compound ester insulating oil according to claim 8, wherein the synthesis and purification module comprises:
a constant temperature oil reservoir used for esterification+vacuum distillation;
a digital constant temperature magnetic stirrer used for adsorption and washing;
a circulating water vacuum pump and a vacuum oil pump used for suction filtration; and
a vacuum drying oven used for vacuum drying.

10. The system for the preparation process of multi-compound ester insulating oil according to claim 8, wherein the mixing module comprises:
a digital constant temperature magnetic stirrer used for stirring and oscillation;
a vacuum drying oven used for drying degassing.
